(19) United States
(12) Patent Application Publication
(10) Pub. No.: US 2009/0106776 A1
(43) Pub. Date: Apr. 23, 2009

(54) Apparatus and method for managing events in virtual world

(75) Inventors: Han-cheol Kim, Yongin-si (KR); Do-Kyoon Kim, Seongnam-si (KR); Chang-su Kim, Suwon-si (KR); Jin-hyung Park, Yongin-si (KR); Jeong-joon Yoo, Yongin-si (KR); Jae-don Lee, Paju-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/153,150

(22) Filed: May 14, 2008

(30) Foreign Application Priority Data
Oct. 23, 2007 (KR) 10-2007-0106850

(51) Int. Cl. G06F 9/44

(52) U.S. Cl. 719/318

(57) ABSTRACT

Provided is an apparatus for managing events in a virtual world. The apparatus includes: an event detecting unit monitoring a virtual world and detecting an event which occurs in the virtual world; a snapshot managing unit generating snapshots of developments of the event; and a control unit providing each of the generated snapshots in real time.

### CROSS-REFERENCE TO RELATED APPLICATION

This application claims priority from Korean Patent Application No. 10-2007-0106850 filed on Oct. 23, 2007 in the Korean Intellectual Property Office, the disclosure of which is incorporated herein by reference in its entirety.

### BACKGROUND OF THE INVENTION

1. Field of the Invention

The present invention relates to an apparatus and method for managing events in a virtual world, and more particularly, to an apparatus and method for automatically detecting a dynamic event which occurs in a virtual world and providing information regarding the changed situation inside the virtual world in real time.

2. Description of the Related Art

Generally, a virtual world refers to an Internet-based, three-dimensional (3D) virtual space. The virtual world is a new world in which people lead new lives using avatars as their other selves. In a virtual space, people from around the world can make friends, participate in community activities, and do business and shopping.

The virtual space consists of numerous virtual worlds such as web pages, and people can move between various virtual worlds, that is, navigate between web pages.

However, it requires significantly longer time to move between virtual worlds than between conventional web screens, especially when a virtual world that a user intends to enter includes high-quality 3D objects. In addition, even when the user enters the virtual world after downloading the 3D objects for a long time, if the virtual world is not as interesting as the user expected, the user may select another virtual world based only on its name and without knowing what is happening in the selected virtual world and enter the selected virtual world. Thus, every time when the user moves between virtual worlds in this way, the user will repeatedly experience a slowdown while 3D objects included in each virtual world that the user intends to enter are downloaded.

FIG. 1 shows a conventional virtual world search screen. Referring to FIG. 1, a user stores information regarding incidents, which occur in a real world, in a system and retrieves the information in a web environment by using a keyword. In the virtual space, the user searches for a virtual world based on the name of the virtual world which is stored in the system, not on a dynamic incident, and moves to the found virtual world (search page) using a terminal.

Specifically, when an information creator has an experience or when a special incident occurs in a real word, user (for example, the information creator) organizes and edits contents of his or her experience or the incident that occurred in the real world. After a period of time, the information creator goes to the place where the information creator had the experience or where the incident occurred, takes photographs of the place, writes a news report, and edits the photographs and the news report in order to upload them to a web page.

Then, the information creator inputs text-based tagging information of the edited information regarding the experience or the incident to allow a user to easily retrieve the edited information and registers the edited information with a system. After edited information regarding experiences or incidents which occurred in the real world are registered with the system as described above, a user inputs a keyword to search for information regarding a desired virtual world.

Accordingly, a search page 10 providing a list of virtual worlds, which match the input keyword, is displayed on a client terminal as shown in FIG. 1. When the user selects a desired virtual world from the list, a representative image 20 of the virtual world is also displayed.

If the user clicks on a teleport key to move to the selected virtual world, the current screen is changed to the selected virtual world (web page). Then, the selected virtual world (web page) is downloaded to the client terminal through a network, and thus the user can see inside the virtual world.

Here, when the user fails to find desired information in the selected virtual world, the user may search for another virtual world or select another virtual world from the previously retrieved list of virtual worlds to download another virtual world (web page).

However, since the client terminal provides only a list of names of virtual worlds that matches each keyword and a representative image of each virtual world, the user cannot identify situations inside a virtual world before entering the virtual world. Furthermore, the client terminal slows down while downloading many object included in a desired virtual world after the user selects the virtual world from the list.

In order to view dynamic situations happening in a virtual world, the user has to enter the virtual world, explore the virtual world using his or her avatar, and determine whether the virtual world is as interesting as the user expected. If the virtual world is not as interesting as the user expected, the user has to search for another virtual world again.

Since the system is configured based on information regarding the real world, it is difficult to create and retrieve information regarding an incident or experience which dynamically unfolds in the virtual world. Information regarding an incident or experience dynamically unfolding in the real world is not digital data. Thus, an information creator creates the information after the incident or experience occurred, edits the information as digital information, and stores the edited information in the system. Such time difference between the occurrence of the incident or experience and the creation and storage of the information regarding the incident or experience makes it impossible for a user to retrieve real-time data.

### SUMMARY OF THE INVENTION

Aspects of the present invention provide an apparatus and method for managing events in a virtual world, in which a dynamic event that occurs in a virtual world is automatically detected, and a snapshot of the event is generated and provided in real time.

However, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, there is provided an apparatus for managing events in a virtual world. The apparatus includes: an event detecting unit monitoring a virtual world and detecting an event which occurs in the virtual world; a snapshot managing unit generating snapshots of developments of the event; and a control unit providing each of the generated snapshots in real time.

According to another aspect of the present invention, there is provided a method of managing events in a virtual world. The method includes: monitoring a virtual world and detecting an event which occurs in the virtual world; generating snapshots of developments of the event; and providing each of the generated snapshots in real time.

### BRIEF DESCRIPTION OF THE DRAWINGS

The above and other aspects and features of the present invention will become more apparent by describing in detail exemplary embodiments thereof with reference to the attached drawings, in which:

FIG. 1 shows a conventional virtual world search screen;

FIG. 2 shows an apparatus for managing events in a virtual world and a client terminal according to an exemplary embodiment of the present invention;

FIG. 3 is a block diagram of an apparatus for managing events in a virtual world according to an exemplary embodiment of the present invention;

FIG. 4 is a flowchart illustrating a process in which the apparatus of FIG. 3 monitors a virtual world to detect the occurrence of an event and stores information regarding developments of the event, wherein the process is included in a method of managing events in a virtual world according to an exemplary embodiment of the present invention;

FIG. 5 is a flowchart illustrating a process of providing information regarding virtual worlds which match an input keyword, where the process is included in the method of managing events in a virtual world according to the exemplary embodiment of the present invention; and

FIGS. 6A and 6B are screen images displayed on a client terminal when a user of the client terminal searches for a virtual world according to an exemplary embodiment of the present invention.

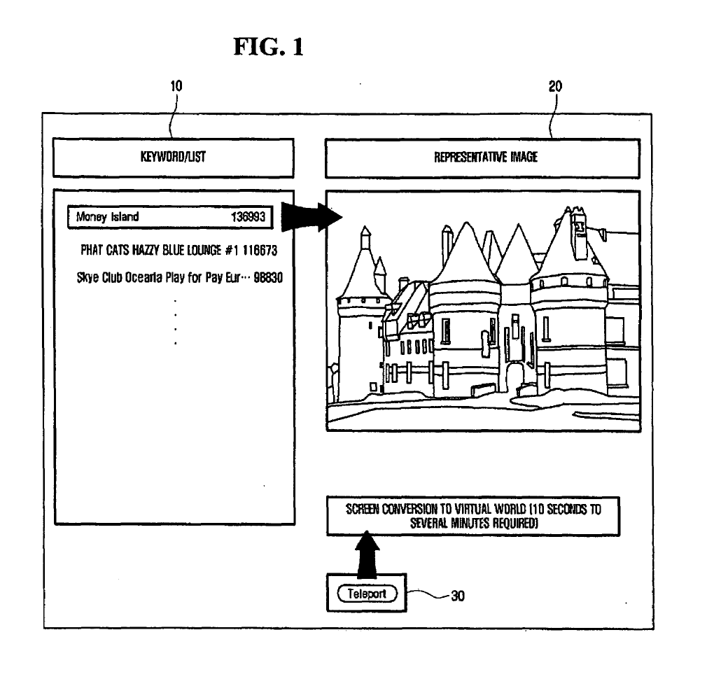

### DETAILED DESCRIPTION OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

Hereinafter, exemplary embodiments of the present invention will be described with reference to the attached drawings.

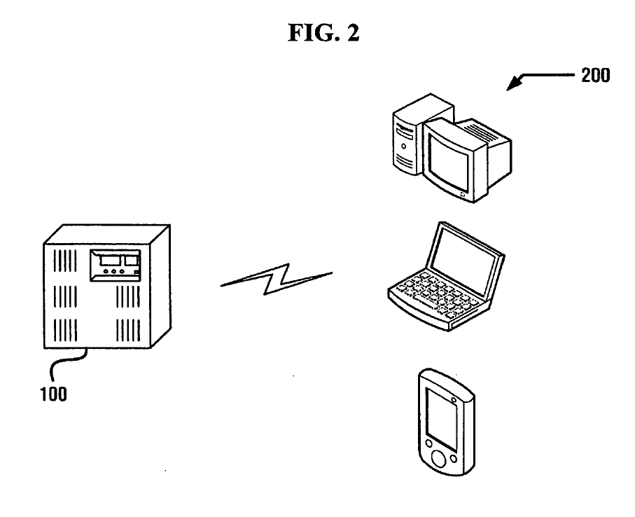

FIG. 2 shows an apparatus 100 for managing events in a virtual world and a client terminal 200 according to an exemplary embodiment of the present invention.

Referring to FIG. 2, the apparatus 100 monitors a virtual world, detects events that occur in the virtual world, and manages the detected events. Here, events refer to experiences of an avatar that exists in a virtual world or incidents that happen in the virtual world. The experiences of the avatar existing in the virtual world may include trying on clothing while doing the shopping and dancing with someone. In addition, the incidents that happen in the virtual world may include all kinds of situations in the virtual world, such as a situation where a concert is being held and a situation where a thief is being chased.

Specifically, when an event occurs in a virtual world while the apparatus 100 is monitoring the virtual world, the apparatus 100 detects information (such as still images, moving images and texts) regarding the event and generates tagging information of the event using text information which is included in the detected information.

Then, the apparatus 100 generates snapshots of developments of the event. Here, snapshots are generated for important developments of the event. For example, when a fire breaks out in a building, snapshots of important developments unfolding during the event (that is, from when the fire breaks out in the building to when the fire is extinguished) are generated, such as a snapshot of the building on fire, a snapshot of fire trucks being dispatched to the fire scene, a snapshot of people being rescued from the building, and a snapshot of the building after the fire is extinguished.

Next, the apparatus 100 stores the detected information regarding the event and the generated snapshots. Later, when the apparatus 100 receives from a user of the client terminal 200 a request to search for a virtual world, the apparatus 100 provides the client terminal 200 with a list of virtual worlds which match the received keyword and snapshots of developments of an event in a selected virtual world.

Specifically, when a user inputs a keyword, the client terminal 200 provides a list of virtual worlds that match the keyword. When the user selects a desired virtual world from the list, the client terminal 200 provides snapshots of developments of an event which occurs in the selected virtual world. Here, if the event in the selected virtual world develops constantly and dynamically, the client terminal 200 displays snapshots of the developments of the event in real time. Accordingly, the user can be provided with latest state information of the virtual world. In the present invention, the client terminal 200 may be a device which can make Internet communications, such as a mobile phone, a personal digital assistant (PDA), a portable multimedia player, a smart phone, a desktop, or a notebook.

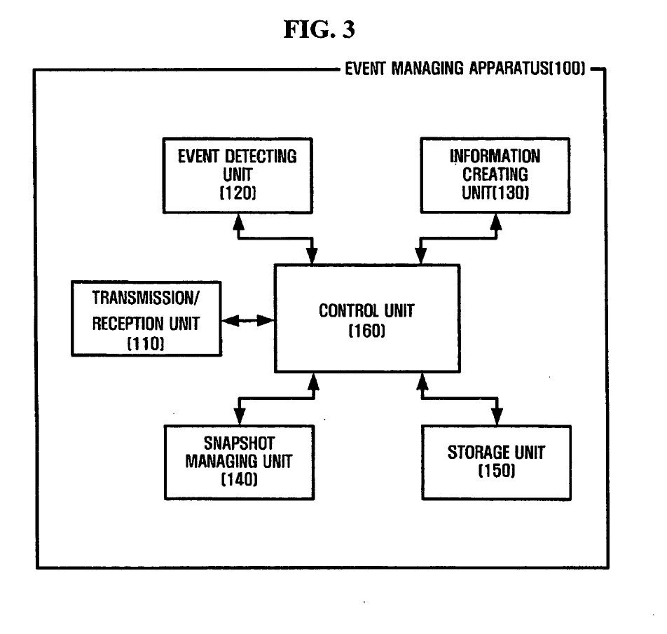

FIG. 3 is a block diagram of an apparatus 100 for managing events in a virtual world according to an exemplary embodiment of the present invention.

Referring to FIG. 3, the apparatus 100 includes a transmission/reception unit 110, an event detecting unit 120, an information creating unit 130, a snapshot managing unit 140, a storage unit 150 and a control unit 160.

The term ‘unit’, as used herein, means, but is not limited to, a software or hardware component, such as a Field Programmable Gate Array (FPGA) or Application Specific Integrated Circuit (ASIC), which performs certain tasks. A unit may advantageously be configured to reside on the addressable storage medium and configured to execute on one or more processors. Thus, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or further separated into additional components and units.

The transmission/reception unit 110 receives a keyword input by a user of the client terminal 200 and transmits to the client terminal 200 a list of virtual worlds which match the received keyword, a representative snapshot of a virtual world selected by the user from the list, and snapshots of developments of an event which occurs in the selected virtual world.

The event detecting unit 120 monitors a virtual world to detect an event which occurs in the virtual world. Here, the virtual world is monitored using a distributed program at regular time intervals in order to detect the occurrence of an event.

When the event detecting unit 120 detects a new event which occurs in the virtual world, the information creating unit 130 detects information (such as still images, moving images and texts) regarding the event and stores the detected information in the storage unit 150.

In addition, the information creating unit 130 creates tagging information of the event using text information included in the detected information and stores information (such as still images, moving images and texts) regarding developments of the event based on the created tagging information. In this way, the information regarding the event which occurred in the virtual world is continuously modified and stored.

The snapshot managing unit 140 generates snapshots of major scenes of the virtual world and the event which occurred in the virtual world and manages the generated snapshots. In this case, the snapshot managing unit 140 generates snapshots of important experiences of an avatar or important incidents from what the avatar experienced or what happened in the virtual world, that is, snapshots of important happenings included in an event which occurs in the virtual world. Thus, when an event occurs, a plurality of snapshots may be generated.

In addition, the snapshot managing unit 140 generates snapshots of developments of the event and stores the generated snapshots in the storage unit 150.

The storage unit 150 stores the event information (such as still images, moving images and texts) detected by the information creating unit 130, the tagging information of the event, a representative image of the virtual world, and the snapshots of the event.

The control unit 160 searches for virtual worlds based on a keyword input by the user and provides a list of virtual worlds.

For example, when the user inputs a keyword “shopping,” the control unit 160 searches the storage unit 150 for tagging information which matches the input keyword. If the control unit 160 finds the tagging information which matches the input keyword, it provides a list of virtual worlds associated with the found tagging information and a representative image of each virtual world to the client terminal 200. When the user selects the name of a desired virtual world from the received list, if there are snapshots of developments of an event which currently occurs in the selected virtual world, the control unit 160 transmits the snapshots to the client terminal 200 in real time.

However, if no event currently occurs in the virtual world selected by the user, the control unit 160 provides a representative image of the selected virtual world or the representative image of the selected virtual world and snapshots of an event which has previously occurred.

In addition, the control unit 160 controls the operation of each of the transmission/reception unit 110, the event detecting unit 120, the information creating unit 130, the snapshot managing unit 140 and the storage unit 150 included in the apparatus 100.

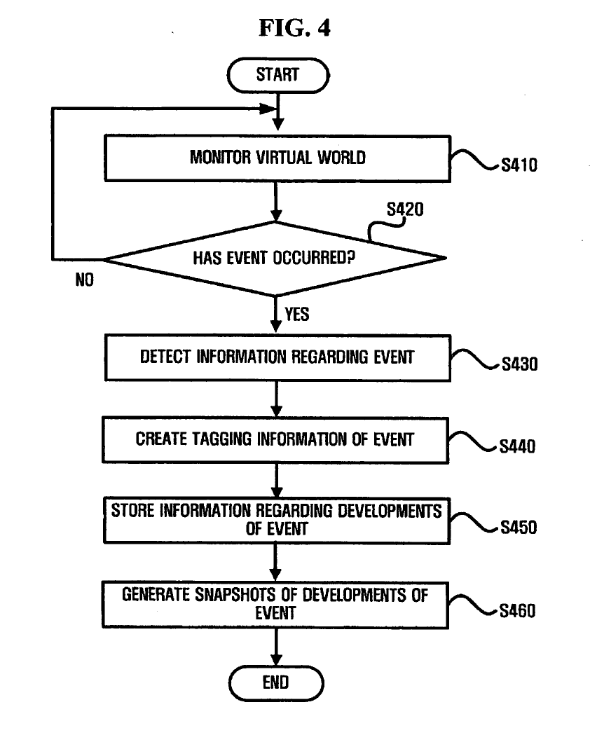

FIG. 4 is a flowchart illustrating a process in which the apparatus 100 of FIG. 3 monitors a virtual world to detect the occurrence of an event and stores information regarding developments of the event, wherein the process is included in a method of managing events in a virtual world according to an exemplary embodiment of the present invention.

Referring to FIG. 4, the event detecting unit 120 of the apparatus 100 periodically monitors a virtual world to detect an event (such as an experience of an avatar existing in the virtual world or an incident happening in the virtual world) which may occur in the virtual world (operation S410). Here, the virtual world is monitored using a distributed program.

When an event occurs, the event detecting unit 120 detects the event. When the event is detected (yes to the question raised in operation S420), the information creating unit 130 detects information (such as still images, moving images and texts) regarding the event (operation S430).

Then, the information creating unit 130 generates tagging information of the event using text information included in the detected information (operation S440) and stores information (such as still images, moving images and texts) regarding developments of the event based on the generated tagging information (operation S450).

Next, the snapshot managing unit 140 generates snapshots of the developments of the event (operation S460). Here, snapshots are generated for important developments unfolding during the event. The information regarding the event which occurred in the virtual world and the generated snapshots are stored. In addition, whenever a snapshot is generated, the client terminal 200 provides the generated snapshot to a user. Therefore, the user can recognize, in real time, a dynamic event which occurs in the virtual world.

On the other hand, when detecting no event in the virtual world while monitoring the virtual world (no to the question raised in operation S420), the event detecting unit 120 continues to monitor the virtual world periodically (operation S410).

When no event currently occurs in the virtual world or when all events have been terminated, the client terminal 200 displays only a representative image of the virtual world or the representative image of the virtual world and snapshots of an event which has previously occurred.

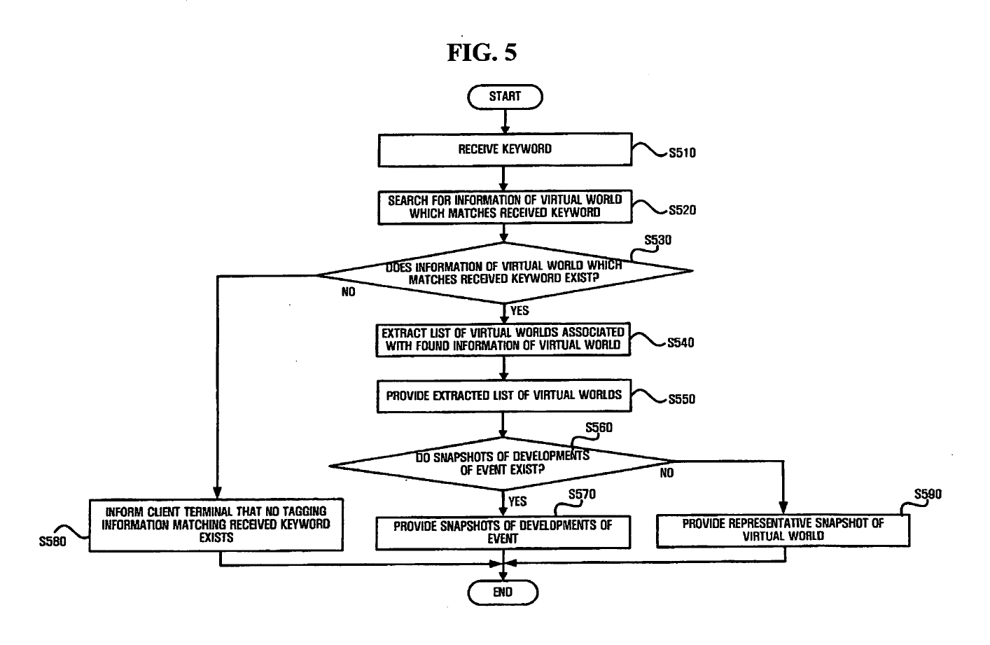

FIG. 5 is a flowchart illustrating a process of providing information regarding virtual worlds which match an input keyword, where the process is included in the method of managing events in a virtual world according to the exemplary embodiment of the present invention.

Referring to FIG. 5, when a user inputs a keyword to the client terminal 200 in order to obtain information regarding a specified virtual world, the transmission/reception unit 110 of the apparatus 100 receives the keyword from the client terminal 200 (operation S510).

Then, the control unit 160 searches the storage unit 150 for tagging information which matches the received keyword (operation S520). When the control unit 160 finds the tagging information which matches the received keyword (yes to the question raised in operation S530), it extracts a list of virtual worlds associated with the found tagging information and provides the extracted list to the client terminal 200 via the transmission/reception unit 110 (operations S540 and S550).

Accordingly, the transmitted list of virtual worlds are displayed on the client terminal 200, and, when the user selects the name of a desired virtual world from the displayed list, the control unit 160 checks whether there are snapshots of developments of an event which occurs in the selected virtual world.

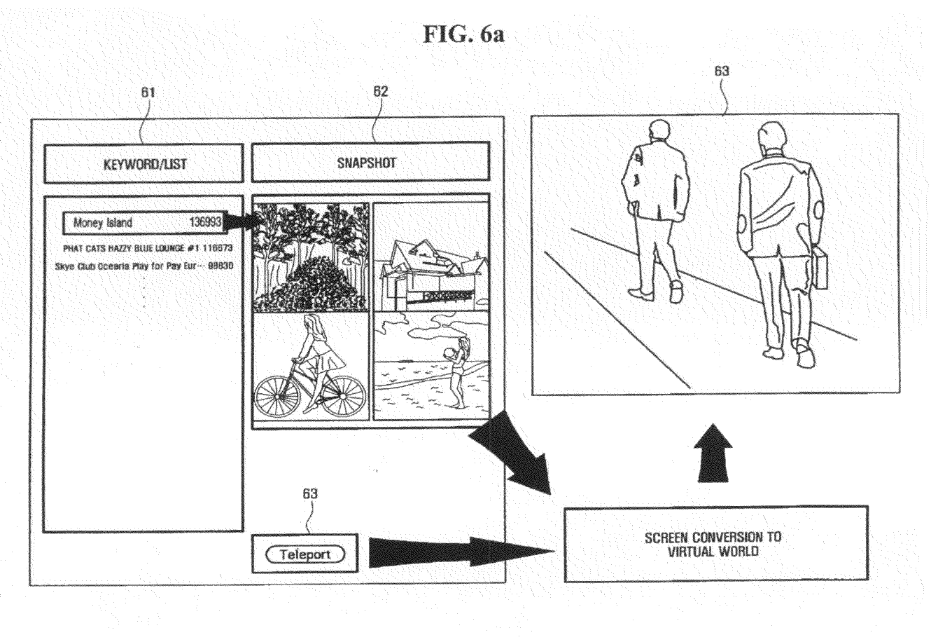

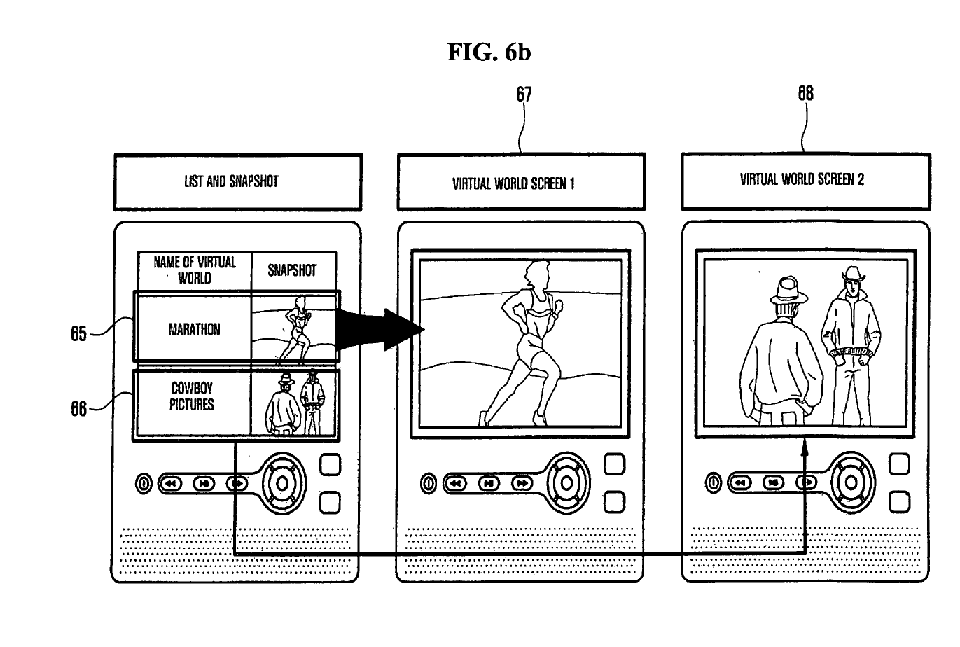

If the snapshots of the developments of the event exist (yes to the question raised in operation S560), the control unit 160 transmits the snapshots to the client terminal 200, which, in turn, displays the snapshots thereon (operation S570). Since the user of the client terminal 200 is provided with a snapshot of the dynamically changing event, the user can quickly recognize the situation inside the virtual world. Screen images provided on the client terminal 200 will be described in detail with reference to FIGS. 6A and 6B.

However, if the snapshots of the developments of the event do not exist, that is, if no event currently occurs (no to the question raised in operation S560), the control unit 160 provides a representative snapshot of the virtual world to the client terminal 200 (operation S590). When no event currently occurs, the control unit 160 may provide only a representative snapshot of the virtual world or the representative snapshot of the virtual world and snapshots of an event which has previously occurred.

On the other hand, when the control unit 160 finds no tagging information which matches the received keyword (no to the question raised in operation S530), it informs the client terminal 200 that no tagging information matching the received keyword existed by using the transmission/reception unit 110 (operation S580).

Whenever a snapshot of a new event is generated, the control unit 160 transmits, in real time, the generated snapshot to the client terminal 200 via the transmission/reception unit 110.

FIGS. 6A and 6B are screen images displayed on a client terminal 200 when a user of the client terminal 200 searches for a virtual world according to an exemplary embodiment of the present invention.

Referring to FIG. 6A, when a user inputs a search word (or a keyword) to the client terminal 200, the apparatus 100 searches for virtual worlds which match the input search word and provides a list of found virtual worlds to the client terminal 200, which, in turn, displays the list thereon as indicated reference numeral 61.

When the user places a cursor on the name (for example, Money Island) of a virtual world selected from the displayed list, snapshots of developments of an event which occurs in the selected virtual world are displayed on the client terminal 200 as indicated by reference numeral 62.

After viewing the snapshots, if the user wants to enter the selected virtual world, the user selects a teleport key 63. When the user selects the teleport key 63, the user is connected to a page address of the selected virtual world on the name of which the cursor is currently placed and thus can enter the selected virtual world as indicated by reference numeral 64.

FIG. 6B shows a list of virtual worlds and snapshots displayed on a small-sized client terminal 200.

Referring to FIG. 6B, when a user selects, for example, the name “Marathon” of a virtual world from a list of virtual worlds displayed on the client terminal 200, snapshots of an event which occurs in the selected virtual world are displayed as indicated by reference numeral 65. After viewing the snapshots, if the user selects a teleport key in order to enter the selected virtual world, the user is connected to a page address of the selected virtual world, on the name (that is, marathon) of which the cursor is currently placed, and thus can enter the selected virtual world as indicated by reference numeral 67.

In addition, when the user selects the name ‘Cowboy Pictures’ of another virtual world from the displayed list of virtual worlds, snapshots of an event which occurs in the selected virtual world are displayed as indicated by reference numeral 66. After viewing the snapshots, if the user selects the teleport key in order to enter the selected virtual world, the user is connected to a page address of the selected virtual world, on the name (that is, cowboy pictures) of which the cursor is currently placed, and thus can enter the virtual world as indicated by reference numeral 68.

Since a snapshot of a dynamically changing event in a virtual world is provided in real time, the user of the client terminal 200 can quickly recognize the changing event.

As described above, an apparatus and method for managing events in a virtual world according to the present invention provide at least one of the following advantages.

The present invention automatically detects a dynamic event which occurs in a virtual world and provides a snapshot of the event. Therefore, a user can quickly recognize the changed situation inside the virtual world.

In addition, since the user can view snapshots related to a virtual world, the user can identify the situation inside the virtual world without entering the virtual world and downloading virtual objects. Hence, the network and display performance of low-specification client terminals can be enhanced.

According to the present invention, a system itself detects a dynamically changing event and creates information regarding the event. Thus, there is no need for a person to monitor a virtual world and create tagging information.

Furthermore, since the present invention provides, in real time, dynamically changing event information in a virtual world, the user can be provided with latest information about the virtual world.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. An apparatus for managing events in a virtual world, the apparatus comprising:
an event detecting unit monitoring a virtual world and detecting an event which occurs in the virtual world;
a snapshot managing unit generating snapshots of developments of the event; and
a control unit providing each of the generated snapshots in real time.

2. The apparatus of claim 1, wherein the event is an experience of an avatar which exists in the virtual world or an incident which happens in the virtual world.

3. The apparatus of claim 1, further comprising an information creating unit detecting information regarding the event and storing the detected information.

4. A method of managing events in a virtual world, the method comprising:
monitoring a virtual world and detecting an event which occurs in the virtual world;
generating snapshots of developments of the event; and
providing each of the generated snapshots in real time.

5. The method of claim 4, wherein the event is an experience of an avatar which exists in the virtual world or an incident which happens in the virtual world.

6. The method of claim 4, further comprising detecting information regarding the event and storing the detected information.

7. The method of claim 6, wherein the detecting of the information regarding the event and the storing of the detected information comprises:
detecting the information regarding the event;
generating tagging information of the event based on the detected information; and
storing the detected information and the generated tagging information.

8. The method of claim 4, wherein the providing of each of the generated snapshots in real time comprises:
determining whether a new snapshot of the event has been generated; and
providing the snapshot to a client terminal in real time if it is determined that the snapshot has been generated.
